(19) United States
(12) Patent Application Publication
(10) Pub. No.: US 2025/0144526 A1
(43) Pub. Date: May 8, 2025

(54) ANIMATION PROCESSING METHOD AND APPARATUS, ELECTRONIC DEVICE, COMPUTER-READABLE STORAGE MEDIUM, AND COMPUTER PROGRAM PRODUCT

(71) Applicant: Tencent Technology (Shenzhen) Company Limited, Shenzhen (CN)

(72) Inventors: Shilei CHEN, Shenzhen (CN); Jichun Hou, Shenzhen (CN); Tao Xu, Shenzhen (CN); Bo Hu, Shenzhen (CN)

(21) Appl. No.: 19/015,408

(22) Filed: Jan. 9, 2025

Related U.S. Application Data
(63) Continuation of application No. PCT/CN2023/129769, filed on Nov. 3, 2023.

(30) Foreign Application Priority Data
Feb. 1, 2023 (CN) 2023100491515.5

(51) Int. Cl. A63F 13/56

(52) U.S. Cl. CPC A63F 13/56; A63F 2300/6607

(57) ABSTRACT

An animation processing method is performed by an electronic device. The method includes: determining a target movement parameter matching a target movement instruction for controlling movement of a virtual object; driving movement of a logic entity based on the target movement parameter; predicting, while driving the movement of the logic entity based on the target movement parameter, a first predicted trajectory of a representation entity based on the target movement parameter, the representation entity being configured to represent the virtual object; selecting, from a preset animation library, a target animation adapted to the first predicted trajectory, the preset animation library including animations corresponding to various moving actions respectively; driving movement of the representation entity based on the target animation; and rendering a moving animation of the virtual object in a virtual scene based on the movement of the logic entity and the movement of the representation entity.

### CROSS-REFERENCE TO RELATED APPLICATIONS

This application is a continuation application of PCT Patent Application No. PCT/CN2023/129769, entitled “ANIMATION PROCESSING METHOD AND APPARATUS, ELECTRONIC DEVICE, COMPUTER-READABLE STORAGE MEDIUM, AND COMPUTER PROGRAM PRODUCT” filed on Nov. 3, 2023, which is based upon and claims priority to Chinese Patent Application No. 202310049151.5, entitled “ANIMATION PROCESSING METHOD AND APPARATUS, ELECTRONIC DEVICE, COMPUTER-READABLE STORAGE MEDIUM, AND COMPUTER PROGRAM PRODUCT” filed on Feb. 1, 2023, both of which are incorporated by reference in their entirety.

### FIELD OF THE TECHNOLOGY

This application relates to an animation processing technology in the field of computer applications, and in particular, to an animation processing method and apparatus, an electronic device, a computer-readable storage medium, and a computer program product.

### BACKGROUND OF THE DISCLOSURE

A moving animation of a virtual object in a virtual scene is rendered together by movement of a logic entity and movement of a representation entity. In general, in order to realize the rendering of the moving animation, a program-driven mode may be adopted. To be specific, a moving parameter of the logic entity is determined based on a received target movement instruction to drive the movement of the logic entity, the logic entity and the representation entity are bound positionally, and an animation is selected based on the determined moving parameter to drive the movement of the representation entity in accordance with the determined moving parameter and the selected animation. Thus, when there is a deviation between the moving parameter of the selected animation and the moving parameter determined based on the target movement instruction, slip occurs in the representation entity. Therefore, the rendering quality of the moving animation is affected.

### SUMMARY

Embodiments of this application provide an animation processing method and apparatus, an electronic device, a computer-readable storage medium, and a computer program product, which can reduce the probability of occurrence of slip and improve the rendering quality of a moving animation.

Technical solutions in embodiments of this application are implemented as follows:

Embodiments of this application provide an animation processing method performed by an electronic device. The method includes:
determining, based on a corresponding relationship between moving instructions and moving parameters, a target movement parameter matching a target movement instruction for controlling movement of a virtual object;
driving movement of a logic entity based on the target movement parameter, where the logic entity is configured to perform logic operations corresponding to the virtual object;
predicting, while driving the movement of the logic entity based on the target movement parameter, a first predicted trajectory of a representation entity based on the target movement parameter, where the representation entity is configured to represent the virtual object;
selecting, from a preset animation library, a target animation adapted to the first predicted trajectory, where the preset animation library includes animations corresponding to various moving actions respectively;
driving movement of the representation entity based on the target animation; and
rendering a moving animation of the virtual object in a virtual scene based on the movement of the logic entity and the movement of the representation entity.

Embodiments of this application provide an electronic device for animation processing, including:
a memory, configured to store computer-executable instructions or computer programs; and
a processor, configured to implement, when executing the computer-executable instructions stored in the memory, the animation processing method provided in embodiments of this application.

Embodiments of this application provide a non-transitory computer-readable storage medium, storing computer-executable instructions. The computer-executable instructions, when executed by a processor of an electronic device, causing the electronic device to implement the animation processing method provided in embodiments of this application.

Embodiments of this application at least have the following beneficial effects. When a moving animation of a virtual object in a virtual scene is rendered, movement of a logic entity is driven based on a target movement parameter determined from a target movement instruction, and movement of a representation entity is driven based on a selected target animation. Therefore, the logic entity and the representation entity can be separated in terms of moving information, so that the moving information of the representation entity moving depends on moving information of the target animation, thereby reducing the probability of deviation between the moving information of the representation entity and the moving information of the target animation, further reducing the probability of occurrence of slip, and improving the rendering quality of the moving animation.

### BRIEF DESCRIPTION OF THE DRAWINGS

FIG. 1 is an exemplary schematic diagram of a program-driven mode.

FIG. 2 is an exemplary schematic diagram of position synchronization.

FIG. 3 is another exemplary schematic diagram of position synchronization.

FIG. 4 is an exemplary schematic diagram of an animation-driven mode.

FIG. 5 is an exemplary schematic diagram of a combination-driven mode.

FIG. 6 is an exemplary schematic diagram of an architecture of an animation processing system according to an embodiment of this application.

FIG. 7 is an exemplary schematic diagram of a structure of a terminal in FIG. 6 according to an embodiment of this application.

FIG. 8 is a schematic flowchart I of an animation processing method according to an embodiment of this application.

FIG. 9 is a schematic flowchart II of an animation processing method according to an embodiment of this application.

FIG. 10 is an exemplary schematic diagram of determining a first predicted trajectory according to an embodiment of this application.

FIG. 11 is a schematic flowchart III of an animation processing method according to an embodiment of this application.

FIG. 12 is an exemplary schematic diagram of position determination according to an embodiment of this application.

### DESCRIPTION OF EMBODIMENTS

To make the objectives, technical solutions, and advantages of this application clearer, the following describes this application in further detail with reference to the accompanying drawings. The described embodiments are not to be considered as a limitation to this application. All other embodiments obtained by a person of ordinary skill in the art without creative efforts shall fall within the protection scope of this application.

In the following description, reference is made to “some embodiments” which describe a subset of all possible embodiments. However, “some embodiments” may be the same subset or different subsets of all possible embodiments and may be combined with each other without conflict.

In the following descriptions, the included term “first/second” is intended to distinguish similar objects but does not necessarily indicate a specific order of an object. “First/second” is interchangeable in terms of a specific order or sequence if permitted, so that the embodiments of this application described herein can be implemented in a sequence in addition to the sequence shown or described herein.

Unless otherwise defined, meanings of all technical and scientific terms used in this embodiment are the same as those usually understood by a person skilled in the art to which this application belongs. Terms used in embodiments of this application are merely intended to describe objectives of embodiments of this application, but are not intended to limit this application.

Before embodiments of this application are further described in detail, a description is made on nouns and terms in embodiments of this application, and the nouns and terms in embodiments of this application are applicable to the following explanations.

1) Artificial intelligence (AI) is a theory, method, technology, and application system that uses a digital computer or a machine controlled by the digital computer to simulate, extend, and expand human intelligence, perceive an environment, obtain knowledge, and use knowledge to obtain an optimal result.

2) Machine learning (ML) is a multi-field interdiscipline, and relates to a plurality of disciplines such as the probability theory, statistics, the approximation theory, convex analysis, and the algorithm complexity theory. ML specializes in studying how a computer simulates or implements a human learning behavior to obtain new knowledge or skills, and reorganizes an existing knowledge structure, so as to keep improving its performance. ML is the core of AI, is a basic way to make the computer intelligent, and is applied to various fields of AI. ML generally includes technologies such as an artificial neural network, a belief network, reinforcement learning, transfer learning, and inductive learning.

3) An artificial neural network is a mathematical model that imitates the structure and function of a biological neural network. Exemplary structures include a graph convolutional network (GCN) that is a neural network for processing graph-structured data), a deep neural network (DNN), a convolutional neural network (CNN) and a recurrent neural network (RNN), a neural state machine (NSM), and a phase-functioned neural network (PFNN). In embodiments of this application, a first predicted trajectory and a second predicted trajectory may be predicted by a model corresponding to the artificial neural network.

4) Response represents a condition or state upon which performed operations depend, where one or more of the performed operations may be real-time or may have a set delay when the dependent condition or state is satisfied. Without being specifically stated, there is no limitation to the order in which the operations are performed.

5) A virtual scene may be a simulated environment of a real world, or may be a semi-simulated semi-fictional virtual environment, or may be an entirely fictional virtual environment. The virtual scene may be any one of a two-dimensional virtual scene, a 2.5-dimensional virtual scene, or a three-dimensional virtual scene, and the dimension of the virtual scene is not limited in embodiments of this application. For example, the virtual scene may include a virtual sky, a virtual land, and a virtual ocean. The virtual land may include environmental elements such as a virtual desert and a virtual city. A user or intelligent control logic may control a virtual object to move in the virtual scene.

6) A virtual object is an image that may perform interaction with various persons and things in a virtual scene, or is another movable object in the virtual scene. The movable object may be a virtual person, a virtual animal, a cartoon person, a virtual prop, or the like. The virtual object may be a virtual image configured to represent a user in the virtual scene. A plurality of virtual objects may be included in the virtual scene. Each virtual object has own shape and volume in the virtual scene, and occupies a portion of the space in the virtual scene.

7) A client is an application run in a device for providing various services, such as a game client, a simulation client, or a video client.

8) Cloud computing is a computing mode, in which computing tasks are distributed on a resource pool formed by a large quantity of computers, so that various application systems can obtain computing power, storage space, and information services according to requirements. A network that provides resources for a resource pool is referred to as a “cloud”. For a user, the resources in the “cloud” seem to be infinitely expandable, and may be obtained readily, used on demand, expanded readily, and paid for use. An animation processing method provided in embodiments of this application may be implemented by cloud computing.

9) Cloud gaming is also referred to as gaming on demand, and is an online gaming technology based on a cloud computing technology. The cloud gaming technology enables a thin client having graphics processing and data computing capabilities lower than specified capabilities to run games smoothly. In a cloud gaming scene, a game is not run on a game terminal of a player, but run in a cloud server, and the cloud server renders the gaming scene as an audio and video stream for transmission to the game terminal of the player through the network. The graphics computing and data processing capabilities of the game terminal of the player are lower than the specified capabilities, and the game can be run through basic streaming media playback capabilities and the capability to obtain player input instructions and transmit the instructions to the cloud server. The animation processing method provided in embodiments of this application may be applied to the cloud gaming scene.

10) A logic object, also referred to as a logic entity, is a logic virtual object. Therefore, the logic object is an invisible virtual object, representing a real logic position of the virtual object on an electronic device (such as a client device or a server).

11) A representation object, also referred to as a representation entity, is a presented virtual object. A virtual object includes a collision entity for interacting with a physical world, and a mounted art model, where the collision entity for interacting with the physical world is the logic entity, and the mounted art model is the representation entity. The position of the representation entity is always close to the position of the logic entity. Therefore, for example, in a game application, the consistency of a virtual character in each terminal device (including each client device and each server device) can be ensured, thereby ensuring the consistency of the player experience and the game logic.

12) Slip means a phenomenon in which moving information of the representation entity does not match moving information of a played animation. For example, the slip may be caused by a mismatch between moving information of an animation when the position of the logic entity is not corrected and moving information of the representation entity, or may be caused by a mismatch between moving information of an animation when the position of the logic entity is corrected and moving information of the representation entity.

The movement of the virtual object is implemented together by the logic entity and the representation entity. The representation entity is configured to display a virtual object model and play a virtual object animation. Each animation frame includes moving information, which is referred to as a root motion here. For example, the root motion may be projection information of a hip bone on a moving ground, or may be a result of smoothing or fine-tuning of a projection of the hip bone on the moving ground. The smoothing or fine-tuning is intended to solve the problem that moving smoothness is low (less than second smoothness) caused by low projection smoothness (less than first smoothness), thereby improving the smoothness of movement. In addition, the smoothing or fine-tuning may be implemented by a sliding window. For example, projection information corresponding to previous three animation frames, a current animation frame, and next three animation frames is averaged, and a position obtained by averaging is determined as the result of smoothing or fine-tuning of the current animation frame.

In general, the movement of the virtual object may be driven in three modes: an animation-driven mode, a program-driven mode, and a combination-driven mode.

In the program-driven mode, various moving parameters (such as an accelerated speed, a maximum speed, a rotation speed, and a friction force) are set in advance. The movement of the logic entity is driven by the moving parameters, and the representation entity and the logic entity are completely bound positionally. When an engine (such as a game engine) is running, in response to a target movement instruction for a virtual object (such as an input operation in a controller of a player or a movement navigation command of a non-player character (NPC)), a position change of the logic entity is calculated frame by frame through a physical simulation algorithm, thereby also obtaining a position change of the representation entity. Next, based on the position change of the logic entity per frame, a moving state such as a current moving speed and a moving direction of the logic entity is determined, a matching animation segment is selected based on the moving state, and the selected animation segment is played by the representation entity. Reference is made to FIG. 1. FIG. 1 is an exemplary schematic diagram of a program-driven mode. As shown in FIG. 1, in the program-driven mode, a moving parameter 1-2 is determined in response to a moving instruction 1-1, and movement of a logic entity 1-3 is driven based on the moving parameter 1-2 to determine a position change of the logic entity 1-3 per frame. Since a representation entity 1-4 and the logic entity 1-3 are positionally bound at this moment, moving information of the representation entity 1-4 and the logic entity 1-3 are consistent with each other. The position change of the logic entity 1-3 per frame is a position change of the representation entity 1-4 per frame.

In the program-driven mode, a moving parameter is determined based on a received target movement instruction to drive movement of a logic entity, the logic entity and a representation entity are bound positionally, and an animation is selected based on the determined moving parameter to drive movement of the representation entity in accordance with the determined moving parameter and the selected animation. Thus, when there is a deviation between the moving parameter of the selected animation and the moving parameter determined based on the target movement instruction, slip occurs in the representation entity. Moreover, for an animation of motion capture, since the animation of motion capture is obtained by capturing moving data of a motion capture actor, moving parameters (an accelerated speed, a maximum speed, a turning speed, etc.) are preset by a designer according to own expectations. On the one hand, moving actions of the motion capture actor cannot be completely consistent with the moving parameters, and on the other hand, the moving parameters also have the possibility of modification. Therefore, there is often a deviation between the moving parameter of the animation and the moving parameter corresponding to the target movement instruction, thereby improving the probability of slip.

In the process of the program-driven mode, the slip caused by the mismatch between the moving parameter of the animation and the moving parameter corresponding to the target movement instruction may be triggered by correcting the position of the logic entity on the client device with the position of the logic entity on the server. At this moment, different correction modes are adopted for a manually controlled virtual object (such as a player virtual character) and an automatically controlled virtual object (such as a non-player virtual character), respectively, so as to realize position synchronization between the position of the logic entity on the client device and the position of the logic entity on the server.

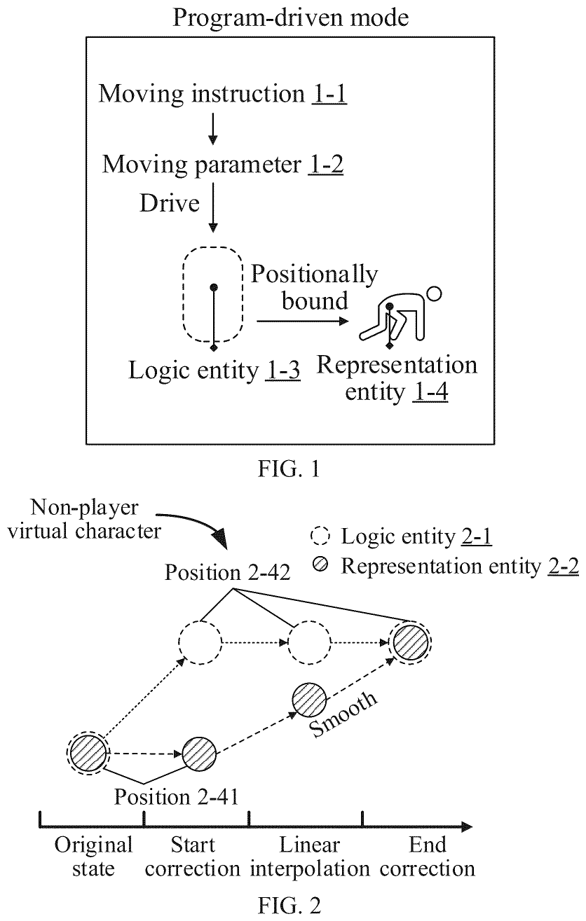

For the automatically controlled virtual object, exemplarily, reference is made to FIG. 2. FIG. 2 is an exemplary schematic diagram of position synchronization. As shown in FIG. 2, for a non-player virtual character, when the positions of a logic entity 2-1 of a client device and a logic entity of a server are deviated, at the start of correction (i.e. position synchronization), the positions of the logic entity 2-1 of the client and a representation entity 2-2 are separated, the logic entity 2-1 of the client is moved from a position 2-41 in an original state to a position 2-42 of the logic entity of the server, and the representation entity 2-2 is located at the original position 2-41. Next, the representation entity 2-2 is smoothly moved to the position 2-42 of the logic entity 2-1 of the client for a period of time in the future by using linear interpolation, and the correction is completed, thereby reducing the probability of position jumping of the representation entity. However, at this moment, a moving speed of the animation is a moving speed of the logic entity, the moving speed of the logic entity of the client is a speed corresponding to a moving parameter, and a moving speed of the representation entity is the speed corresponding to the moving parameter and a correction speed. Thus, the moving speed of the animation does not match the moving speed of the representation entity, and there is a problem of slip.

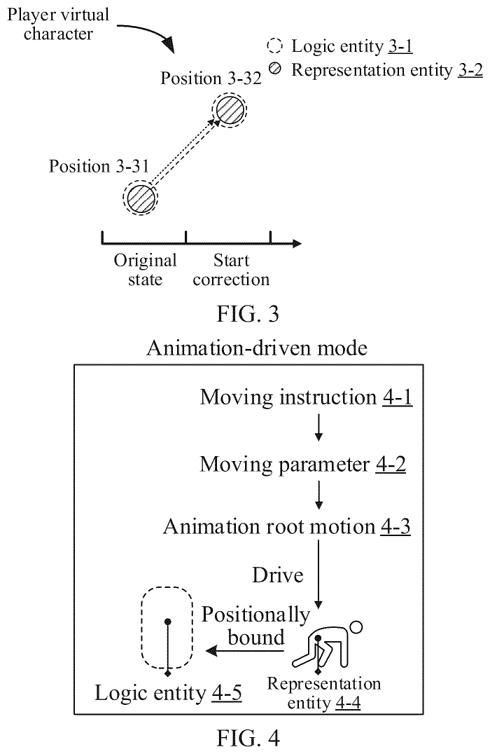

For the manually controlled virtual object, exemplarily, reference is made to FIG. 3. FIG. 3 is another exemplary schematic diagram of position synchronization. As shown in FIG. 3, for a player virtual character, when the positions of a logic entity 3-1 of a client device and a logic entity of a server are deviated, at the start of correction, the logic entity 3-1 of the client device and a representation entity 3-2 are directly moved from a position 3-31 in an original state to a position 3-32 of the logic entity of the server. Thus, the position of the representation entity 3-2 is jumped, and there is a problem of slip.

In the animation-driven mode, according to a moving instruction of a virtual object, a corresponding animation is selected to be played, and the logic entity and the representation entity are bound positionally. Thus, both a moving parameter of the logic entity and a moving parameter of the representation entity correspond to a moving parameter of the selected animation. Reference is made to FIG. 4. FIG. 4 is an exemplary schematic diagram of an animation-driven mode. As shown in FIG. 4, in the animation-driven mode, a moving parameter 4-2 is determined in response to a moving instruction 4-1, an animation is selected based on the moving parameter 4-2, and movement of a representation entity 4-4 is driven based on a selected animation root motion 4-3. Since a logic entity 4-5 and the representation entity 4-4 are bound positionally in the animation-driven mode, movement of the logic entity 4-5 is driven based on the animation.

In the animation-driven mode, the logic entity and the representation entity are bound positionally. For example, although slip does not occur in a single-player game, a mode of bringing the positions of the representation entity and the logic entity closer is similar to a mode in a code-driven mode when the position of the logic entity of the client device is corrected based on the position of the logic entity of the server when position synchronization (such as online gaming). Repeated descriptions are omitted herein in embodiments of this application. In addition, in the animation-driven mode, since the running logic of the animation is inconsistent in various devices (including at least one client device and server), when the animations are mixed with each other, a mixing result is deviated in each device, resulting in deviation in the movement of the logic entity on each device, thereby improving the frequency of position synchronization, and improving the frequency of occurrence of slip.

In the combination-driven mode, the movement of the logic entity is driven by the combination of the moving parameter and an animation root motion, as shown in Equation (1).

$${T}_{logic} = W * {T}_{code} + ( 1 - W ) * {T}_{anim} , \qquad ( 1 )$$

where T_{logic} represents the position of the logic entity, T_{code} represents the position determined according to the moving parameter corresponding to the moving instruction, Tₐₙᵢₘ represents the position corresponding to the moving information of the animation, and W represents a weight parameter less than 1.

In the combination-driven mode, the movement of the representation entity is driven by the animation root motion, as shown in Equation (2).

$${T}_{mesh} = {T}_{anim} , \qquad ( 2 )$$

where Tₘₑₛₕ represents the position of the representation entity.

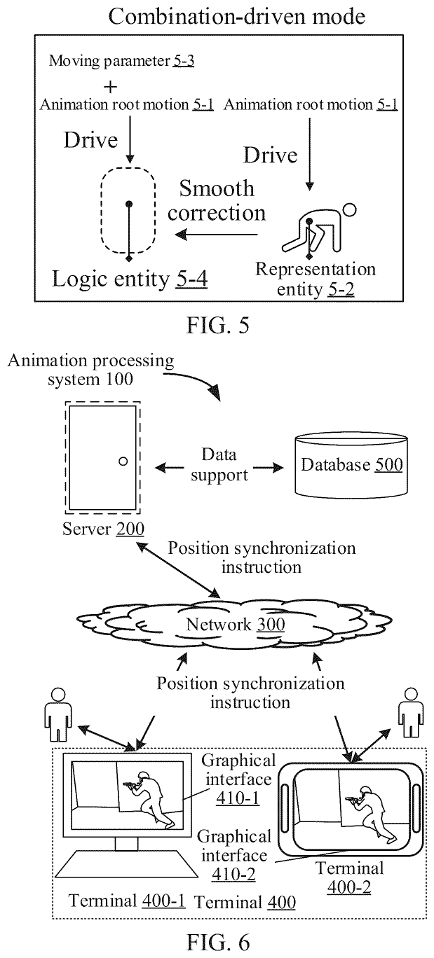

Reference is made to FIG. 5. FIG. 5 is an exemplary schematic diagram of a combination-driven mode. As shown in FIG. 5, in the combination-driven mode, movement of a representation entity 5-2 is driven based on a selected animation root motion 5-1. Movement of a logic entity 5-4 is driven in accordance with the animation root motion 5-1 and a moving parameter 5-3 corresponding to a moving instruction. And in the moving process of the representation entity 5-2 and the logic entity 5-4, the representation entity 5-2 is smoothly corrected to the position of the logic entity 5-4.

When the movement of the logic entity is driven in accordance with the moving parameter corresponding to the moving instruction and the animation root motion and animation mixture is triggered, the probability of position deviation of the logic entity on a client device and a server is higher (greater than a specified probability), thereby improving the frequency of position correction. In addition, in the process of animation matching, an animation is usually selected based on a specified interval duration (such as 0.1 seconds), and in order to avoid a bone posture jumping in two adjacent animations, an animation posture and the root motion are often mixed. Since an animation mixing duration (such as 0.3 seconds) is higher than the specified interval duration of the selected animation, there are at least two animations mixed at each moment. In the animation mixing state, the probability of position synchronization is improved, and the frequency of occurrence of slip is improved.

In addition, in the combination-driven mode, the movement of logic entity on the server is driven based on an animation, and the animation is selected by running an animation system. The running of the animation system increases the resource consumption and affects the processing efficiency of a moving animation.

Based on this, embodiments of this application provide an animation processing method and apparatus, an electronic device, a computer-readable storage medium, and a computer program product, which can reduce the probability of occurrence of slip and the resource consumption and improve the rendering quality and efficiency of a moving animation. The following describes an exemplary application of an electronic device for animation processing (hereinafter simply referred to as an animation processing device) provided in embodiments of this application. The animation processing device provided in embodiments of this application may be implemented as various types of terminals such as a smartphone, a smart watch, a laptop computer, a tablet computer, a desktop computer, a smart home appliance, a set-top box, a smart in-vehicle device, a portable music player, a personal digital assistant, a dedicated messaging device, a smart voice interaction device, a portable gaming device, and a smart speaker, and may also be implemented as a server, or a combination of a terminal and a server. Exemplary applications are described below when an animation processing device is implemented as a terminal.

Reference is made to FIG. 6. FIG. 6 is an exemplary schematic diagram of an architecture of an animation processing system according to an embodiment of this application. As shown in FIG. 6, to support an animation processing application, in an animation processing system 100, a terminal 400 (a terminal 400-1 and a terminal 400-2 are exemplarily shown, referred to as an animation processing device) is connected to a server 200 via a network 300. The network 300 may be a wide area network or a local area network, or a combination of the two networks. In addition, the animation processing system 100 further includes a database 500 for providing data support to the server 200. Moreover, FIG. 6 shows a case in which the database 500 is independent of the server 200. Furthermore, the database 500 may be further integrated in the server 200. This is not limited in embodiments of this application.

The terminal 400 is configured to: determine, based on a corresponding relationship between moving instructions and moving parameters, a target movement parameter matching a target movement instruction for controlling movement of a virtual object; receive a position synchronization instruction transmitted by the server 200 via the network 300, control a logic entity to move to a second current position in response to the position synchronization instruction, and start to drive movement of the logic entity from the second current position based on the target movement parameter, where the logic entity is configured to perform logic operations corresponding to the virtual object; predict, in the process of driving the movement of the logic entity based on the target movement parameter, a first predicted trajectory of a representation entity based on the target movement parameter, where the representation entity is configured to represent the virtual object; select, from a preset animation library, a target animation adapted to the first predicted trajectory, where the preset animation library includes animations corresponding to various moving actions respectively; drive movement of the representation entity based on the target animation; and render a moving animation of the virtual object in a virtual scene based on the movement of the logic entity and the movement of the representation entity (a graphical interface 410-1 and a graphical interface 410-2 are exemplarily shown).

The server 200 is configured to transmit the position synchronization instruction to the terminal 400 via the network 300, where the position synchronization instruction includes a second current position.

In some embodiments, the server 200 may be an independent physical server, or may be a server cluster including a plurality of physical servers or a distributed system, or may be a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform. The terminal and the server may be directly or indirectly connected in a wired or wireless communication mode. This is not limited in embodiments of this application.

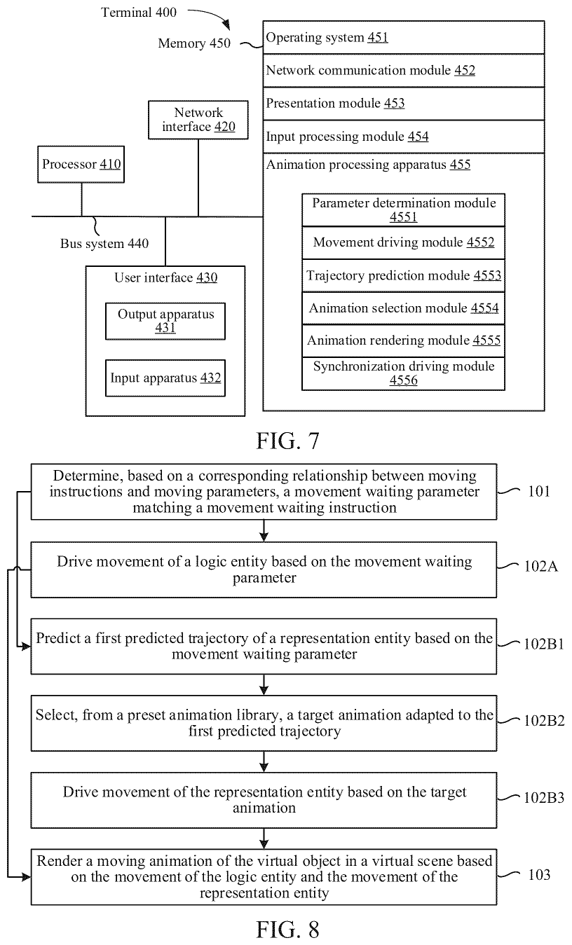

Reference is made to FIG. 7. FIG. 7 is an exemplary schematic diagram of a structure of a terminal in FIG. 6 according to an embodiment of this application. As shown in FIG. 7, a terminal 400 includes: at least one processor 410, a memory 450, at least one network interface 420, and a user interface 430. Components in the terminal 400 are coupled by a bus system 440. The bus system 440 is configured to implement connection and communication between the components. In addition to a data bus, the bus system 440 further includes a power bus, a control bus, and a state signal bus. However, for case of clear description, all types of buses in FIG. 7 are marked as the bus system 440.

The processor 410 may be an integrated circuit chip having signal processing capabilities, for example, a general-purpose processor, a digital signal processor (DSP), or another programmable logic device, discrete gate or transistor logic device, or discrete hardware component. The general-purpose processor may be a microprocessor, any conventional processor, or the like.

The user interface 430 includes one or more output apparatuses 431 that enable the presentation of media content, including one or more speakers and/or one or more visual display screens. The user interface 430 further includes one or more input apparatuses 432, including user interface components that facilitate user input, such as a keyboard, a mouse, a microphone, a touch-screen display, a camera, or another input button and control.

The memory 450 may be removable, non-removable, or a combination thereof. Exemplary hardware devices include solid state memories, hard disk drives, optical disk drives, and the like. In some embodiments, the memory 450 includes one or more storage devices physically located away from the processor 410.

The memory 450 includes a volatile memory or a non-volatile memory, or may include both a volatile memory and a non-volatile memory. The non-volatile memory may be a read-only memory (ROM), and the volatile memory may be a random access memory (RAM). The memory 450 described in this embodiment of this application aims to include any suitable type of memory.

In some embodiments, the memory 450 is capable of storing data to support various operations. Examples of the data include programs, modules, and data structures or subsets or supersets thereof, as exemplified below.

An operating system 451 includes a system program for processing various basic system services and executing hardware-related tasks, such as a framework layer, a core library layer, and a driver layer, for realizing various basic services and processing hardware-based tasks.

A network communication module 452 is configured to reach other electronic devices via one or more (wired or wireless) network interfaces 420. The network interface 420 exemplarily includes: Bluetooth, wireless fidelity (Wi-Fi), a universal serial bus (USB), and the like.

A presentation module 453 is configured to enable presentation of information through the one or more output apparatuses 431 (for example, display screens or speakers) associated with the user interface 430 (for example, a user interface configured to operate a peripheral device and display content and information).

An input processing module 454 is configured to detect one or more user inputs or interactions from one of the one or more input apparatuses 432 and translate the detected inputs or interactions.

In some embodiments, the animation processing apparatus provided in embodiments of this application may be implemented in software. FIG. 7 shows an animation processing apparatus 455 stored in a memory 450, which may be software in the form of a program and a plug-in. The apparatus includes the following software modules: a parameter determination module 4551, a movement driving module 4552, a trajectory prediction module 4553, an animation selection module 4554, an animation rendering module 4555, and a synchronization driving module 4556. These modules are logical, and therefore may be arbitrarily combined or further split according to an implemented function. The functions of the modules are described below.

In some embodiments, the animation processing apparatus provided in embodiments of this application may be implemented by hardware. As an example, the animation processing apparatus provided in embodiments of this application may be a processor in the form of a hardware decoding processor, programmed to perform the animation processing method provided in embodiments of this application. For example, the processor in the form of the hardware decoding processor may use one or more application specific integrated circuits (ASIC), a DSP, a programmable logic device (PLD), a complex programmable logic device (CPLD), a field-programmable gate array (FPGA), or other electronic components.

In some embodiments, the terminal or the server may implement the animation processing method provided in embodiments of this application by running a computer program. For example, the computer program may be a native program or a software module in an operating system, may be a native application (APP), i.e. a program that needs to be installed in the operating system to run, such as a livestreaming APP or a game APP, or may be a mini program that can be embedded into any APP, i.e. a program that only needs to be downloaded into a browser environment to run. In general, the computer program may be any form of application, module, or plug-in.

The following describes the animation processing method provided in embodiments of this application below with reference to an exemplary application and implementation of an animation processing device provided in embodiments of this application. In addition, the animation processing method provided in embodiments of this application is applied to various animation processing scenarios such as a cloud technology, AI, smart transportation, games, and vehicles.

Reference is made to FIG. 8. FIG. 8 is a schematic flowchart I of an animation processing method according to an embodiment of this application. The following provides descriptions with reference to operations shown in FIG. 8. An animation processing device is used as an execution entity for the operations in FIG. 8.

Operation 101: Determine, based on a corresponding relationship between moving instructions and moving parameters, a target movement parameter matching a target movement instruction.

In embodiments of this application, a virtual object to be moved in a virtual scene is presented on an animation processing device. When movement of the virtual object is controlled by at least one of: a user operation, a test case, an intelligent control instruction, a movement trigger event, and a received moving request, etc., the animation processing device also receives a target movement instruction for controlling the movement of the virtual object. In addition, the animation processing device is provided with a corresponding relationship between moving instructions and moving parameters, or the animation processing device can obtain a corresponding relationship between moving instructions and moving parameters from another device (for example, a storage device such as a database). The corresponding relationship between moving instructions and moving parameters describes a corresponding relationship between all moving instructions and all moving parameters, and a target movement instruction is a moving instruction. Thus, the animation processing device searches the corresponding relationship between moving instructions and moving parameters for a moving instruction matching the target movement instruction, and determines a moving parameter corresponding to the found matching moving instruction as a target movement parameter matching the target movement instruction.

The corresponding relationship between moving instructions and moving parameters is preset before the target movement instruction is received. The moving instructions are various instructions for controlling the movement of the virtual object, such as an instruction to trigger a left movement, an instruction to trigger movement stop, or an instruction to trigger a deceleration. The moving parameters are moving data for driving the movement of the virtual object, such as an accelerated speed of 1 m/s, a moving direction of 45 degrees, a friction force, or a rotation speed. The moving parameters are various moving parameters described in the program-driven mode. Here, the target movement parameter includes at least one of a movement waiting accelerated speed, a movement waiting direction, a movement waiting dynamic friction force, a deceleration waiting friction force, a movement waiting rotation speed, a movement waiting speed, and a maximum movement waiting speed.

Operation 102A: Drive movement of a logic entity based on the target movement parameter.

In embodiments of this application, after the animation processing device obtains a target movement parameter, the target movement parameter is a moving parameter for driving the movement of the virtual object. Further, in embodiments of this application, since the logic entity of the virtual object is driven based on the moving parameter, the animation processing device drives the movement of the logic entity based on the target movement parameter to perform various logic operations such as collision detection.

The virtual object includes a logic entity. The logic entity is configured to perform logic operations corresponding to the virtual object, such as determination of a moving state, determination of a state value, determination of a virtual scene in which the virtual object is located, and whether the virtual object is hit virtually.

In the process of driving the movement of the logic entity based on the target movement parameter, the animation processing device is further configured to perform operations 102B1 to 102B3. The various operations are described below respectively.

Operation 102B1: Predict a first predicted trajectory of a representation entity based on the target movement parameter.

In embodiments of this application, after the animation processing device obtains a target movement parameter, the target movement parameter is a moving parameter for driving the movement of the virtual object. Further, in embodiments of this application, since the representation entity of the virtual object tends to the logic entity of the virtual object positionally, the animation processing device predicts a moving trajectory of the representation entity based on the target movement parameter, and determines the predicted moving trajectory of the representation entity as the first predicted trajectory to drive the movement of the representation entity based on the first predicted trajectory.

The virtual object includes a representation entity. The representation entity is configured to present a virtual character, such as a virtual character presented in a screen. The first predicted trajectory is a movement waiting trajectory of the representation entity within a preset prediction duration, and refers to a future moving trajectory of the representation entity. The preset prediction duration is a preset prediction waiting duration, such as 1 second or 0.5 seconds.

Operation 102B2: Select, from a preset animation library, a target animation adapted to the first predicted trajectory.

In embodiments of this application, the animation processing device is provided with a preset animation library, or the animation processing device can obtain a preset animation library from another device. The preset animation library includes animations corresponding to various moving actions respectively. In addition, each animation frame in each animation in the preset animation library includes a root motion for determining a trajectory. Thus, after obtaining the first predicted trajectory, the animation processing device selects at least one segment of animation that best matches the first predicted trajectory from the preset animation library based on the root motion, and determines the selected at least one segment of animation that best matches the first predicted trajectory as a target animation adapted to the first predicted trajectory. Here, the target animation includes at least one segment of animation.

Operation 102B3: Drive movement of the representation entity based on the target animation.

In embodiments of this application, after selecting the target animation, the animation processing device plays the target animation to drive the movement of the representation entity, thereby realizing the presentation of the movement of the virtual object.

The movement of the representation entity is driven based on moving information of the target animation. Even if animation mixture is included in the process of driving the movement of the representation entity based on the target animation, the moving information is independent of the moving information of the logic entity, so that the frequency of position synchronization of the logic entity can be reduced. The animation mixture refers to processing of playing a plurality of animations at the same time, such as fading out of a current animation or fading in of a next animation.

Operation 102A is performed while operations 102B1 to 102B3 are performed, or operations 102B1 to 102B3 are performed while operation 102A is performed

Operation 103: Render a moving animation of the virtual object in a virtual scene based on the movement of the logic entity and the movement of the representation entity.

The animation processing device implements logic operations during the movement of the virtual object by the movement of the logic entity, and implements presentation of the movement of the virtual object by the movement of the representation entity. Thus, a moving animation of the virtual object in the virtual scene can be rendered by the movement of the logic entity and the movement of the representation entity. The moving animation characterizes a moving process of the virtual object combined with logic operations in the virtual scene.

When a moving animation of a virtual object in a virtual scene is rendered, movement of a logic entity is driven based on a target movement parameter determined from a target movement instruction, and movement of a representation entity is driven based on a selected target animation. Therefore, the logic entity and the representation entity can be separated in terms of moving information, so that the moving information of the representation entity moving depends on moving information of the target animation, thereby reducing the probability of deviation between the moving information of the representation entity and the moving information of the target animation, further reducing the probability of occurrence of slip, and improving the fidelity of the moving animation. Further, since the target animation is adapted based on the first predicted trajectory of the representation entity and the first predicted trajectory is predicted based on the target movement parameter of the logic entity, the position consistency of the representation entity and the logic entity during movement is improved. In addition, since the movement of the logic entity is driven based on the target movement parameter and is independent of the animation, the frequency of position synchronization triggered by animation mixture can be reduced, the probability of occurrence of slip can be reduced, and the rendering quality of the moving animation can be improved.

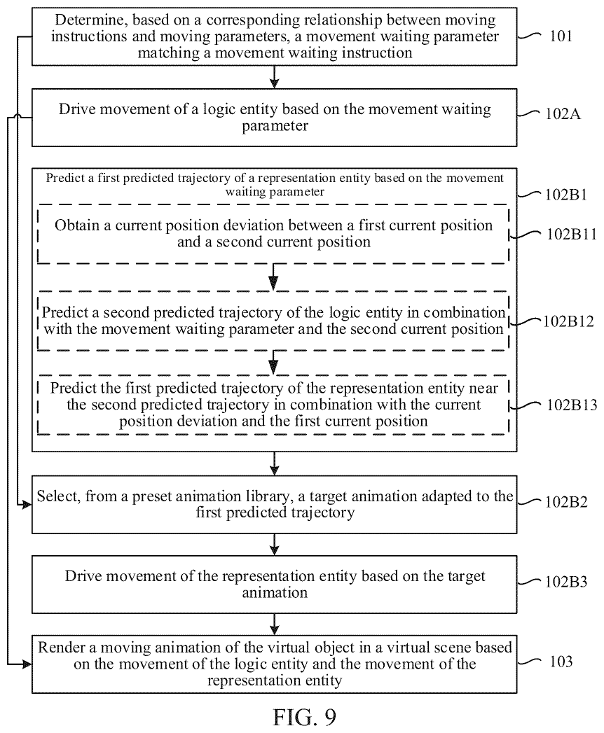

Reference is made to FIG. 9. FIG. 9 is a schematic flowchart II of an animation processing method according to an embodiment of this application. The following provides descriptions with reference to operations shown in FIG. 9. An animation processing device is used as an execution entity for the operations in FIG. 9. As shown in FIG. 9, in embodiments of this application, operation 102B1 may be implemented by operations 102B11 to 102B13. To be specific, the operation of predicting, by the animation processing device, the first predicted trajectory of the representation entity based on the target movement parameter includes operations 102B11 to 102B13. The various operations are described below respectively.

Operation 102B11: Obtain a current position deviation between a first current position and a second current position.

The first current position is a position where the representation entity is currently located, and the second current position is a position where the logic entity is currently located. The current time refers to time when the target movement instruction is received. Here, the animation processing device obtains a position deviation between the first current position and the second current position, thus obtaining a current position deviation. Thus, the current position deviation represents a current position difference between the representation entity and the logic entity, and may refer to a distance, a vector in which the representation entity points to the logic entity, or a vector in which the logic entity points to the representation entity. This is not limited in embodiments of this application.

Operation 102B12: Predict a second predicted trajectory of the logic entity in accordance with the target movement parameter and the second current position.

Since the target movement parameter indicates movement waiting information of the virtual object, the animation processing device predicts a moving trajectory of the logic entity in accordance with the target movement parameter and the second current position, and determines the predicted moving trajectory of the logic entity as a second predicted trajectory. The second predicted trajectory is a moving trajectory of the logic entity within a preset prediction duration, and refers to a future moving trajectory of the logic entity.

Operation 102B13: Predict the first predicted trajectory of the representation entity near the second predicted trajectory in accordance with the current position deviation and the first current position.

In embodiments of this application, the animation processing device may predict a movement waiting trajectory of the representation entity in accordance with the current position deviation and the second predicted trajectory of the logic entity to predict the movement waiting trajectory of the representation entity that can gradually reduce the current position deviation. Thus, the first predicted trajectory near the second predicted trajectory can be predicted. At this moment, the current position deviation refers to a vector in which the logic entity points to the representation entity.

The animation processing device predicts the first predicted trajectory based on the second predicted trajectory of the logic entity, which can reduce a position gap between the logic entity and the representation entity, and further can improve the rendering quality of the moving animation.

In embodiments of this application, in operation 102B12 of FIG. 9, the operation of predicting, by the animation processing device, a second predicted trajectory of the logic entity in accordance with the target movement parameter and the second current position includes: predicting, by the animation processing device, a predicted trajectory segment of the logic entity in accordance with the target movement parameter, a preset prediction duration, and a first current speed; and superimposing the second current position and the predicted trajectory segment to obtain the second predicted trajectory of the logic entity. The operation of predicting, by the animation processing device, a predicted trajectory segment of the logic entity in accordance with the target movement parameter, a preset prediction duration, and a first current speed includes: performing, by the animation processing device, first sampling on the preset prediction duration to obtain a first sampling time sequence; and performing, for each first sampling time in the first sampling time sequence, the following processing: predicting a first predicted position at the first sampling time in accordance with the target movement parameter and the first current speed. Thus, a first predicted position sequence corresponding to the first sampling time sequence is obtained when the first predicted position corresponding to each first sampling time is predicted. Finally, a trajectory segment corresponding to the first predicted position sequence is determined as the predicted trajectory segment of the logic entity.

The second current speed is a current moving speed of the logic entity. The predicted trajectory segment is a movement waiting trajectory segment of the logic entity. Thus, the animation processing device superimposes the second current position and the predicted trajectory segment to obtain the second predicted trajectory of the logic entity. To be specific, the movement waiting trajectory segment determined from the second current position is the second predicted trajectory. Therefore, the second predicted trajectory is a movement waiting trajectory segment of the representation entity relative to the second current position. In addition, the first sampling time sequence includes a plurality of first sampling times. When the animation processing device predicts a first predicted position corresponding to each first sampling time, for example, when the target movement parameter includes a movement waiting accelerated speed and a movement waiting direction, the animation processing device may determine the first predicted position based on a calculation equation of a physical distance. Here, the first predicted position sequence is obtained by combining all the obtained first predicted positions correspondingly according to the first sampling time sequence. In addition, the animation processing device determines a trajectory connecting all of the first predicted positions in the first predicted position sequence as a predicted trajectory segment.

The first sampling may be uniform sampling, random sampling, sampling in which an interval between sampling times increases sequentially, or a combination of the above, etc. This is not limited in embodiments of this application.

In operation 102B13 of FIG. 9 in embodiments of this application, the operation of predicting, by the animation processing device, the first predicted trajectory of the representation entity near the second predicted trajectory in accordance with the current position deviation and the first current position includes: performing, by the animation processing device, second sampling on the preset prediction duration to obtain a second sampling time sequence; and determining, from the second predicted trajectory, a sampling position corresponding to each second sampling time in the second sampling time sequence to obtain a sampling position sequence corresponding to the second sampling time sequence; and performing, for each first weight in a first weight sequence corresponding to the second sampling time sequence, the following processing: fusing the first weight with the current position deviation into a to-be-combined distance, and obtaining a to-be-combined distance sequence corresponding to the first weight sequence, where the first weights in the first weight sequence are decreased in order chronologically (i.e. the order of time occurrence), and the current position deviation is a vector in which the logic entity points to the representation entity; fusing the to-be-combined distance sequence and the sampling position sequence in a one-to-one correspondence to obtain a second predicted position sequence; and finally, predicting the first predicted trajectory of the representation entity near the second predicted trajectory based on the second predicted position sequence and the first current position.

The second sampling may be uniform sampling, random sampling, sampling in which an interval between sampling times increases sequentially, or a combination of the above, etc. This is not limited in embodiments of this application. In addition, the first sampling and the second sampling may be the same sampling or different sampling. When the first sampling and the second sampling are the same sampling, the first sampling time sequence is the same as the second sampling time sequence, and the first predicted position is the sampling position.

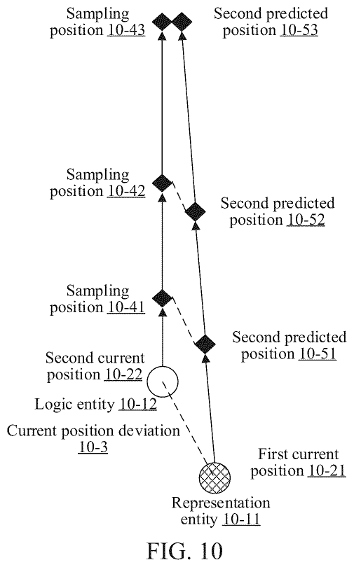

Exemplarily, reference is made to FIG. 10. FIG. 10 is an exemplary schematic diagram of determining a first predicted trajectory according to an embodiment of this application. As shown in FIG. 10, a representation entity 10-11 is currently located at a first current position 10-21, a logic entity 10-12 is currently located at a second current position 10-22, and a position gap between the first current position 10-21 and the second current position 10-22 is a current position deviation of 10-3. The sampling position sequence shown exemplarily includes a sampling position 10-41, a sampling position 10-42, and a sampling position 10-43, and a determined corresponding second predicted position sequence including a second predicted position 10-51, a second predicted position 10-52, and a second predicted position 10-53.

In embodiments of this application, the animation processing device may obtain the first predicted trajectory by: predicting an initial predicted trajectory of the representation entity in accordance with the target movement parameter and the first current position; and obtaining the first predicted trajectory for reducing the current position deviation in combination with a second weight sequence, the current position deviation, and the initial predicted trajectory, where second weights in the second weight sequence are increased in order chronologically. Here, the process of predicting, by the animation processing device, the first predicted trajectory in accordance with the first weight sequence, the current position deviation, and the second predicted trajectory is similar to the process of predicting the first predicted trajectory in accordance with the second weight sequence, the current position deviation, and the initial predicted trajectory, and will not be repeated herein in embodiments of this application. In addition, the two processes differ in that the first weight sequence is adopted in the first process, the second weight sequence is adopted in the second process, the current position deviation in the first process represents a vector in which the logic entity points to the representation entity, and the current position deviation in the second process represents a vector in which the representation entity points to the logic entity.

The mode of predicting, by the animation processing device, the first predicted trajectory in accordance with the first weight sequence, the current position deviation, and the second predicted trajectory is a mode of predicting a moving trajectory of the logic entity and then predicting a first predicted trajectory capable of reducing the current position deviation based on the moving trajectory of the logic entity and the current position deviation. The mode of predicting, by the animation processing device, the first predicted trajectory in accordance with the second weight sequence, the current position deviation, and the initial predicted trajectory is a mode of predicting a moving trajectory of the representation entity and then predicting a first predicted trajectory capable of reducing the current position deviation based on the moving trajectory of the representation entity and the current position deviation. The modes are two different modes of predicting the first predicted trajectory. Therefore, the diversity and flexibility of predicting the first predicted trajectory can be improved. In addition, the first predicted trajectory is obtained based on the predicted moving trajectory of the logic entity, so that the position consistency between the logic entity and the representation entity can be improved, and the fidelity of the moving animation can be further improved.

In embodiments of this application, the animation processing device may further determine the first predicted trajectory by linear interpolation. To be specific, after obtaining a second predicted trajectory, the animation processing device determines a trajectory between an end position of the second predicted trajectory and the first current position as the first predicted trajectory.

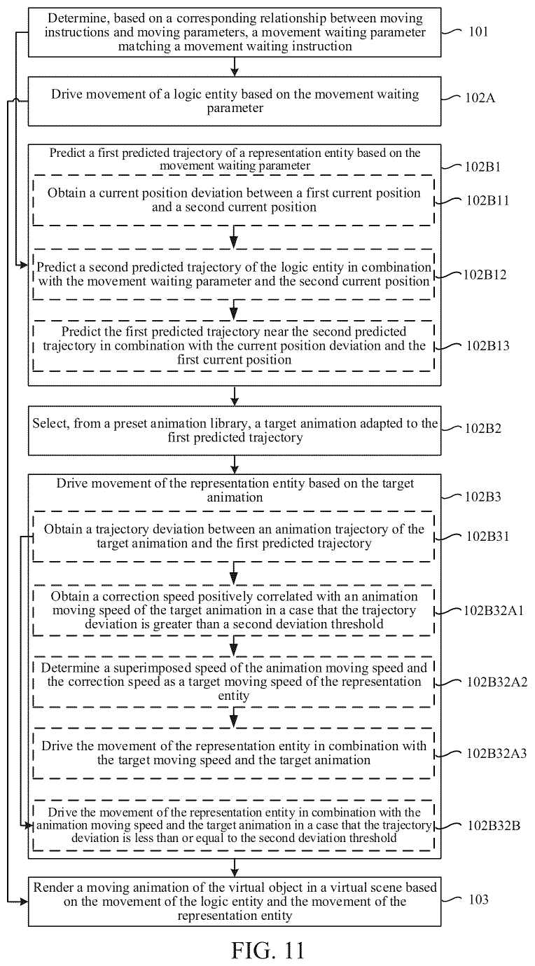

Reference is made to FIG. 11. FIG. 11 is a schematic flowchart III of an animation processing method according to an embodiment of this application. An animation processing device is used as an execution entity for the operations in FIG. 11. As shown in FIG. 11, in embodiments of this application, operation 102B3 in FIG. 8 may be implemented by operations 102B31 and 102B32A1 to 102B32A3. To be specific, the operation of driving, by the animation processing device, the movement of the representation entity based on the target animation includes operations 102B31 and 102B32A1 to 102B32A3. The various operations are described below respectively.

Operation 102B31: Obtain a trajectory deviation between an animation trajectory of the target animation and the first predicted trajectory.

In embodiments of this application, the animation processing device determines a trajectory difference between an animation trajectory of the target animation and the first predicted trajectory as a trajectory deviation. The trajectory deviation represents a degree of fitness between the animation trajectory of the target animation and the first predicted trajectory, and the trajectory deviation is negatively correlated with the degree of fitness.

Operation 102B32A1: Obtain a correction speed positively correlated with an animation moving speed of the target animation when the trajectory deviation is greater than a second deviation threshold.

In embodiments of this application, the animation processing device is provided with a second deviation threshold, or the animation processing device can obtain a second deviation threshold from another device. The second deviation threshold refers to a minimum trajectory deviation that triggers the correction of the speed of the representation entity. Thus, after obtaining a trajectory deviation, the animation processing device compares the trajectory deviation with the second deviation threshold. When the trajectory deviation is greater than the second deviation threshold, it indicates that the trajectory deviation is large, so that speed correction of the representation entity is triggered, and a correction speed positively correlated with the moving speed of the target animation is obtained.

The operation of obtaining, by the animation processing device, a correction speed positively correlated with an animation moving speed of the target animation includes: determining, by the animation processing device, a correction weight positively correlated with the animation moving speed of the target animation, and obtaining the correction speed positively correlated with the correction weight, the animation moving speed, and the current position deviation; or, determining, by the animation processing device, the correction speed positively correlated with a preset correction weight, the animation moving speed, and the current position deviation. To be specific, the animation processing device may determine the correction speed based on a dynamic weight, may determine the correction speed based on a fixed weight, or may determine the correction speed based on a combination of the above. This is not limited in embodiments of this application. In addition, at this moment, the current position deviation refers to a vector in which the representation entity points to the logic entity.

Operation 102B32A2: Determine a superimposed speed of the animation moving speed and the correction speed as a target moving speed of the representation entity.

In embodiments of this application, the animation processing device superimposes the obtained correction speed to the animation moving speed to obtain a superimposed speed which is the target moving speed of the representation entity within the preset prediction duration.

Operation 102B32A3: Drive the movement of the representation entity in accordance with the target moving speed and the target animation.

In embodiments of this application, the animation processing device sets the target moving speed as the moving speed of the representation entity within a preset prediction duration, and plays the target animation to present a moving posture of the representation entity, thereby completing the driving of the movement of the representation entity.

Referring continuously to FIG. 11, operation 102B31 is followed by operation 102B32B. To be specific, after the animation processing device obtains the trajectory deviation between the animation trajectory of the target animation and the first predicted trajectory, the animation processing method further includes operation 102B32B. The various operations are described below respectively.

Operation 102B32B: Drive the movement of the representation entity in accordance with the animation moving speed and the target animation when the trajectory deviation is less than or equal to the second deviation threshold.

In embodiments of this application, the animation processing device compares the trajectory deviation with the second deviation threshold. When the trajectory deviation is less than or equal to the second deviation threshold, it indicates that the trajectory deviation is small, and therefore the movement of the representation entity is directly driven in accordance with the animation moving speed and the target animation.

When the trajectory deviation between the moving trajectory of the selected target animation and the first predicted trajectory is large, the animation processing device corrects the moving speed of the representation entity to reduce the position gap between the representation entity and the logic entity, so that the rendering quality of the moving animation can be improved. In addition, when the animation processing device determines the correction speed based on the animation moving speed, since the correction speed is positively correlated with the animation moving speed, the visibility of the presentation of slip can be reduced, the slip representation can be reduced, and the rendering quality of the moving animation can be further improved.

In embodiments of this application, before operation 102A in FIG. 8, a process of correcting the position of the logic entity is further included. To be specific, before the animation processing device drives the movement of the logic entity based on the target movement parameter, the animation processing method further includes: receiving, by the animation processing device, a position synchronization instruction transmitted by a server device, where the position synchronization instruction includes a second current position; and controlling the logic entity to move to the second current position in response to the position synchronization instruction.

The second current position of the logic entity may refer to a position corrected when the server device performs position synchronization, or may refer to a position to which the current logic entity is moved. This is not limited in embodiments of this application. In addition, the virtual object may be a manually controlled virtual character, an automatically controlled virtual character, or a combination of the two virtual characters. This is not limited in embodiments of this application.

In embodiments of this application, after operation 102B11 in FIG. 9, a process of determining a mode of obtaining the first predicted trajectory based on the current position deviation is further included. To be specific, after the animation processing device obtains the current position deviation between the first current position and the second current position, the animation processing method further includes: predicting, by the animation processing device, the first predicted trajectory of the representation entity in accordance with the target movement parameter, the first current position, and a second current speed when the current position deviation is less than or equal to a first deviation threshold, where the second current speed is a current moving speed of the representation entity. Here, when the current position deviation is less than or equal to the first deviation threshold, the initial predicted trajectory is the first predicted trajectory. In addition, the initial predicted trajectory may be obtained by superimposing the vector in which the logic entity points to the representation entity via the second predicted trajectory.

Correspondingly, in operation 102B12, the operation of predicting, by the animation processing device, a second predicted trajectory of the logic entity in accordance with the target movement parameter and the second current position includes: predicting, by the animation processing device, the second predicted trajectory of the logic entity in accordance with the target movement parameter and the second current position when the current position deviation is greater than the first deviation threshold.

The animation processing device is provided with a first deviation threshold, or the animation processing device can obtain a first deviation threshold from another device.

The first deviation threshold represents a minimum distance that triggers prediction of the first predicted trajectory based on the second predicted trajectory of the logic entity. Thus, when the current position deviation is greater than the first deviation threshold, the selected target animation is an animation that catches up with the logic entity. At this moment, the current position deviation is a distance between the logic entity and the representation entity.

The following describes an exemplary application of embodiments of this application in an actual application scenario. This exemplary application describes the process of reducing slip by controlling the movement of the logic entity and the representation entity in a networked game.

In embodiments of this application, in the networked game, the logic entity and the representation entity are separated. The movement of the logic entity is driven in a program-driven mode, and the movement of the representation entity is driven in an animation-driven mode, as shown in Equation (3).

$${T}_{logic} = {T}_{c ode} , {T}_{mesh} = {T}_{anim} . \qquad ( 3 )$$

Here, since the movement of the logic entity is program-driven, the frequency of correction (referred to as position synchronization) of the position of the logic entity in a networked environment can be reduced. Moreover, the server may turn off the animation system. Thus, the resource consumption of the movement of the virtual character can be reduced. In addition, the movement of the representation entity is animation-driven, so that the moving information of the representation entity is consistent with the moving information of the animation, and the slip of the moving animation can be reduced.

When the movement of the logic entity is driven in the program-driven mode and the movement of the representation entity is driven in the animation-driven mode, an animation selection algorithm (such as Motion Matching) in a catch-up mode and a speed-based position smoothing algorithm may be further adopted in order to reduce the position deviation between the logic entity and the representation entity. The animation selection algorithm in a catch-up mode and the speed-based position smoothing algorithm will be described below respectively.

In embodiments of this application, the animation selection algorithm in a catch-up mode refers to an animation selection algorithm for selecting, from an animation database including various animation actions (referred to a preset animation library), an animation near a future moving trajectory (referred to as a second predicted trajectory) of the logic entity to drive the movement of the representation entity based on a position deviation (referred to as a current position deviation) between the current logic entity and the representation entity. Through the animation selection algorithm in a catch-up mode, the position of the logic entity and the accumulated position of the distance deviation can be near the position corresponding to the animation, as shown in Equation (4).

$${T}_{code} + = {T}_{anim} , \qquad ( 4 )$$

where [symbol] refers to the position deviation between the current logic entity and the representation entity, i.e. the vector in which the logic entity points to the representation entity.

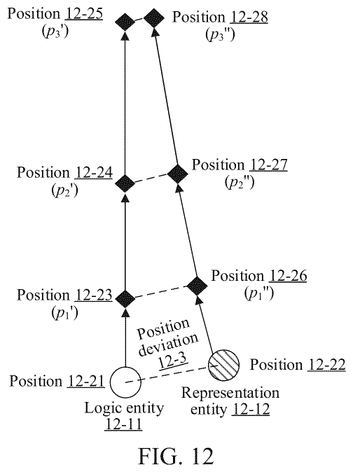

The animation selection algorithm in a catch-up mode is described below with reference to FIG. 12.

Reference is made to FIG. 12. FIG. 12 is an exemplary schematic diagram of position determination according to an embodiment of this application. As shown in FIG. 12, in a current animation frame, a logic entity 12-11 is at a position 12-21 (referred to as a second current position), a representation entity 12-12 is at a position 12-22 (referred to as a first current position), and there is a position deviation 12-3 between the position 12-21 and the position 12-22. When a prediction duration (referred to as a preset prediction duration) is 1 second, three sampling points are determined within 1 second, namely time t₁ (0.33rd second), time t₂ (0.66th second), and time t₃ (1st second) (referred to as a first sampling time sequence). At this moment, exemplarily, trajectory segments p₁, p₂, and p₃ corresponding to the three sampling points are sequentially shown in Equations (5) to (7).

$${p}_{1} = {v}_{0} * {t}_{1} + 1 / 2 * a * {t}_{1}^{2} ; \qquad ( 5 )$$

$${p}_{2} = {v}_{0} * {t}_{2} + 1 / 2 * a * {t}_{2}^{2} ; \qquad ( 6 )$$

$${p}_{3} = {v}_{0} * {t}_{3} + 1 / 2 * a * {t}_{3}^{2} , \qquad ( 7 )$$

where the position of the logic entity relative to the position 12-21 is determined based on p₁, and a position 12-23 (denoted as p₁′, referred to as a sampling position) at which the logic entity 12-11 is located at time t₁ is obtained. The position of the logic entity relative to the position 12-21 is determined based on p₂, and a position 12-24 (denoted as p₂, referred to as a sampling position) at which the logic entity 12-11 is located at time t₂ is obtained. The position of the logic entity relative to the position 12-21 is determined based on p₃, and a position 12-25 (denoted as p₃′, referred to as a sampling position) at which the logic entity 12-11 is located at time t₃ is obtained. a is the moving accelerated speed (referred to as a target movement parameter) determined based on a target movement instruction.

Next, positions of the representation entity corresponding to the three sampling points respectively are predicted based on p₁, p₂, p₃, and weights (referred to as first weights) corresponding to the preset three sampling points respectively, as shown in Equations (8) to (10).

$${p}_{1}^{″} = {p}_{1}^{′} + {w}_{1} * ; \qquad ( 8 )$$

$${p}_{2}^{″} = {p}_{2}^{′} + {w}_{2} * ; \qquad ( 9 )$$

$${p}_{3}^{″} = {p}_{3}^{′} + {w}_{3} * , \qquad ( 10 )$$

where w₁, w₂, and w₃ are decreased in order, w₁ is the weight corresponding to the sampling point at time t₁, w₂ is the weight corresponding to the sampling point at time t₂, and w₃ is the weight corresponding to the sampling point at time t₃. p₁″ represents a position 12-26 at which the representation entity 12-12 is located at time t₁, p₂″ represents a position 12-27 at which the representation entity 12-12 is located at time t₂, and p₃″ represents a position 12-28 at which the representation entity 12-12 is located at time t₃.

Finally, animation selection is performed based on p₁″, p₂″, p₃″, and posture features of the representation entity (such as the current foot bone position and speed of the representation entity).

If there is a position deviation between the current logic entity and the representation entity, the predicted trajectory of the representation entity will be biased from the current position of the representation entity (i.e. the position 12-22) to the predicted trajectory of the logic entity. Thus, a catch-up animation can be selected. For example, when the virtual character moves forward, if the position of the representation entity is shifted to the right relative to the position of the logic entity, an animation moving forward to the left can be selected. When the virtual character moves forward, if the position of the representation entity is shifted to the front relative to the position of the logic entity, an animation decelerating forward can be selected. By driving the representation entity to catch up with the logic entity in this way, the position deviation between the two entities can be reduced while maintaining the original motion direction, and the probability of slip can be reduced.

In embodiments of this application, the speed-based position smoothing algorithm refers to obtaining a target moving speed positively correlated with the moving speed of the animation when the moving information in the selected animation indicates a moving state, and setting the target moving speed as the moving speed of the representation entity when the selected animation causes a position deviation between the logic entity and the representation entity. The process of obtaining the target moving speed is shown in Equation (11).

$${V}_{mesh} = {V}_{anim} + {w}_{4} * ‖ {V}_{anim} ‖ * , \qquad ( 11 )$$

where Vₘₑₛₕ represents the target moving speed of the representation entity corresponding to each animation frame, Vₐₙᵢₘ represents the animation moving speed of the animation frame, [symbol] represents the vector in which the representation entity faces the logic entity, and w₄ is a weight ratio (referred to as a correction weight or a preset correction weight). As w₄ is higher, the correction speed of the position deviation is higher.

As the animation moving speed of the animation frame is higher, the correction speed of the position deviation is higher, and vice versa. Therefore, there is no position deviation correction when the representation entity is in a stop state, and the position deviation correction is performed when the representation entity is in a moving state. Since the movement of the representation entity is dynamic at this moment, the slip representation can be reduced, and the rendering quality of the moving animation can be improved.

In a networked environment, when the server triggers the position correction of the logic entity, the position of the logic entity is set to the position of the logic entity on the server, and the position of the representation entity is corrected to the position of the logic entity by the animation selection algorithm with a catch-up capability and the speed-based position smoothing algorithm. Thus, the position consistency of the representation entity and the logic entity can be ensured, and the rendering quality of the moving animation can be improved.

The following continues to describe an exemplary structure in which an animation processing apparatus 455 provided in embodiments of this application is implemented as a software module. In some embodiments, as shown in FIG. 7, the software module in the animation processing apparatus 455 stored in the memory 450 may include:
a parameter determination module 4551, configured to determine, based on a corresponding relationship between moving instructions and moving parameters, a target movement parameter matching a target movement instruction for controlling movement of a virtual object;
a movement driving module 4552, configured to drive movement of a logic entity based on the target movement parameter, where the logic entity is configured to perform logic operations corresponding to the virtual object;
a trajectory prediction module 4553, configured to predict, in the process of driving the movement of the logic entity based on the target movement parameter, a first predicted trajectory of a representation entity based on the target movement parameter, where the representation entity is configured to represent the virtual object;
an animation selection module 4554, configured to select, from a preset animation library, a target animation adapted to the first predicted trajectory, where the preset animation library includes animations corresponding to various moving actions respectively;
the movement driving module 4552, further configured to drive movement of the representation entity based on the target animation; and
an animation rendering module 4555, configured to render a moving animation of the virtual object in a virtual scene based on the movement of the logic entity and the movement of the representation entity.

In embodiments of this application, the trajectory prediction module 4553 is further configured to: obtain a current position deviation between a first current position and a second current position, where the first current position is a position where the representation entity is currently located, and the second current position is a position where the logic entity is currently located; predict a second predicted trajectory of the logic entity in accordance with the target movement parameter and the second current position; and predict the first predicted trajectory of the representation entity near the second predicted trajectory in accordance with the current position deviation and the first current position.

In embodiments of this application, the trajectory prediction module 4553 is further configured to: predict a predicted trajectory segment of the logic entity in accordance with the target movement parameter, a preset prediction duration, and a first current speed, where the first current speed is a current moving speed of the logic entity; and superimpose the second current position and the predicted trajectory segment to obtain the second predicted trajectory of the logic entity.

In embodiments of this application, the trajectory prediction module 4553 is further configured to: perform first sampling on the preset prediction duration to obtain a first sampling time sequence; and perform, for each first sampling time in the first sampling time sequence, the following processing: predicting a first predicted position at the first sampling time in accordance with the target movement parameter and the first current speed; obtaining a first predicted position sequence corresponding to the first sampling time sequence from the first predicted position at each first sampling time; and determining a trajectory segment corresponding to the first predicted position sequence as the predicted trajectory segment of the logic entity.

In embodiments of this application, the trajectory prediction module 4553 is further configured to: perform second sampling on the preset prediction duration to obtain a second sampling time sequence; determine a sampling position sequence corresponding to the second sampling time sequence from the second predicted trajectory; obtain a first weight sequence corresponding to the second sampling time sequence, where first weights in the first weight sequence are decreased in order chronologically; fuse each of the first weights in the first weight sequence with the current position deviation, respectively, to obtain a to-be-combined distance sequence corresponding to the first weight sequence; fuse the to-be-combined distance sequence and the sampling position sequence in a one-to-one correspondence to obtain a second predicted position sequence; and predict the first predicted trajectory of the representation entity near the second predicted trajectory based on the second predicted position sequence and the first current position.

In embodiments of this application, the trajectory prediction module 4553 is further configured to: predict an initial predicted trajectory of the representation entity in accordance with the target movement parameter and the first current position; and obtain the first predicted trajectory for reducing the current position deviation in combination with a second weight sequence, the current position deviation, and the initial predicted trajectory, where second weights in the second weight sequence are increased in order chronologically.

In embodiments of this application, the movement driving module 4552 is further configured to: obtain a trajectory deviation between an animation trajectory of the target animation and the first predicted trajectory; obtain a correction speed positively correlated with an animation moving speed of the target animation when the trajectory deviation is greater than a second deviation threshold; determine a superimposed speed of the animation moving speed and the correction speed as a target moving speed of the representation entity; and drive the movement of the representation entity in accordance with the target moving speed and the target animation.

In embodiments of this application, the movement driving module 4552 is further configured to: determine a correction weight positively correlated with the animation moving speed of the target animation, and obtain the correction speed positively correlated with the correction weight, the animation moving speed, and the current position deviation; or, determine the correction speed positively correlated with a preset correction weight, the animation moving speed, and the current position deviation.

In embodiments of this application, the movement driving module 4552 is further configured to drive the movement of the representation entity in accordance with the animation moving speed and the target animation when the trajectory deviation is less than or equal to the second deviation threshold.

In embodiments of this application, the animation processing apparatus 455 further includes a position synchronization driving module 4556, configured to: receive a position synchronization instruction transmitted by a server device, where the position synchronization instruction includes a second current position; and control the logic entity to move to the second current position in response to the position synchronization instruction.

In embodiments of this application, the trajectory prediction module 4553 is further configured to predict the first predicted trajectory of the representation entity in accordance with the target movement parameter, the first current position, and a second current speed when the current position deviation is less than or equal to a first deviation threshold, where the second current speed is a current moving speed of the representation entity.

In embodiments of this application, the trajectory prediction module 4553 is further configured to predict the second predicted trajectory of the logic entity in accordance with the target movement parameter and the second current position when the current position deviation is greater than the first deviation threshold.

Embodiments of this application provide a computer program product. The computer program product includes computer-executable instructions or computer programs.

The computer-executable instructions or the computer programs are stored in a computer-readable storage medium. A processor of an animation processing device reads the computer-executable instructions or the computer programs from the computer-readable storage medium, and the processor executes the computer-executable instructions or the computer programs, to cause the animation processing device to perform the animation processing method according to embodiments of this application.

Embodiments of this application provide a non-transitory computer-readable storage medium, having computer-executable instructions or computer programs stored therein. The computer-executable instructions or the computer programs, when executed by a processor, cause a processor to perform the animation processing method provided in embodiments of this application, for example, the animation processing method as shown in FIG. 8.

In some embodiments, the computer-readable storage medium may be a memory such as a FRAM, a ROM, a flash memory, a magnetic surface memory, a compact disc, or a CD-ROM, or may be various devices including one or any combination of the foregoing memories are also possible.

In some embodiments, the computer-executable instructions may be written in the form of a program, software, a software module, a script, or code and according to a programming language (including a compiler or interpreter language or a declarative or procedural language) in any form, and may be deployed in any form, including an independent program or a module, a component, a subroutine, or another unit suitable for use in a computing environment.

As an example, the computer-executable instructions may, but not necessarily, correspond to a file in a file system, and may be stored in a part of the file that stores other programs or data, for example, stored in one or more scripts in a hypertext markup language (HTML) document, stored in a single file dedicated to the program under discussion, or stored in a plurality of collaborative files (for example, a file that stores one or more modules, subroutines, or code parts).

As an example, the computer-executable instructions may be deployed on one electronic device for execution (where in this case, the electronic device is an animation processing device), or executed on a plurality of electronic devices located at one location (where in this case, the plurality of electronic devices located at one location are animation processing devices), or executed on a plurality of electronic devices distributed at a plurality of locations and interconnected through a communication network (where in this case, the plurality of electronic devices distributed at plurality of locations and interconnected through the communication network are animation processing devices).

In embodiments of this application, relevant data such as a target movement instruction is involved. When embodiments of this application are applied to a specific product or technology, user permission or consent needs to be obtained, and collection, use, and processing of the relevant data need to comply with relevant laws, regulations, and standards of relevant countries and regions.

By reason of the foregoing, in embodiments of this application, when a moving animation of a virtual object in a virtual scene is rendered, movement of a logic entity is driven based on a target movement parameter determined from a target movement instruction, and movement of a representation entity is driven based on a selected target animation. Therefore, the logic entity and the representation entity can be separated in terms of moving information, so that the moving information of the representation entity moving depends on moving information of the target animation, thereby reducing the probability of deviation between the moving information of the representation entity and the moving information of the target animation, and further reducing the probability of occurrence of slip. In addition, in embodiments of this application, a moving trajectory of the representation entity is predicted based on a predicted trajectory of the logic entity, so that the target animation selected based on the moving trajectory of the representation entity can reduce a position deviation between the representation entity and the logic entity. Also, a correction speed of the representation entity is determined based on an animation moving speed, so that the slip representation can be reduced. To sum up, the rendering quality of a moving animation can be improved.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules or units. Moreover, each module or unit can be part of an overall module or unit that includes the functionalities of the module or unit. The foregoing descriptions are merely embodiments of this application and are not intended to limit the protection scope of this application. Any modification, equivalent replacement, or improvement made within the spirit and scope of this application fall within the protection scope of this application.

What is claimed is:

1. An animation processing method performed by an electronic device, the method comprising:
determining a target movement parameter matching a target movement instruction for controlling movement of a virtual object based on a corresponding relationship between moving instructions and moving parameters;
driving movement of a logic entity based on the target movement parameter, the logic entity being configured to perform logic operations corresponding to the virtual object;
while driving the movement of the logic entity based on the target movement parameter, predicting a first predicted trajectory of a representation entity based on the target movement parameter, the representation entity being configured to represent the virtual object;
selecting, from a preset animation library, a target animation adapted to the first predicted trajectory;
driving movement of the representation entity based on the target animation; and
rendering a moving animation of the virtual object in a virtual scene based on the movement of the logic entity and the movement of the representation entity.

2. The method according to claim 1, wherein the predicting a first predicted trajectory of a representation entity based on the target movement parameter comprises:
obtaining a current position deviation between a first current position and a second current position, the first current position being a position where the representation entity is currently located, and the second current position being a position where the logic entity is currently located;
predicting a second predicted trajectory of the logic entity in accordance with the target movement parameter and the second current position; and
predicting the first predicted trajectory of the representation entity near the second predicted trajectory in accordance with the current position deviation and the first current position.

3. The method according to claim 2, wherein the predicting a second predicted trajectory of the logic entity in accordance with the target movement parameter and the second current position comprises:
predicting a predicted trajectory segment of the logic entity in accordance with the target movement parameter, a preset prediction duration, and a first current speed, the first current speed being a current moving speed of the logic entity; and
superimposing the second current position and the predicted trajectory segment to obtain the second predicted trajectory of the logic entity.

4. The method according to claim 3, wherein the predicting a predicted trajectory segment of the logic entity in accordance with the target movement parameter, a preset prediction duration, and a first current speed comprises:
performing first sampling on the preset prediction duration to obtain a first sampling time sequence; and
performing, for each first sampling time in the first sampling time sequence, the following processing: predicting a first predicted position at the first sampling time in accordance with the target movement parameter and the first current speed;
obtaining a first predicted position sequence corresponding to the first sampling time sequence from the first predicted position at each first sampling time; and
determining a trajectory segment corresponding to the first predicted position sequence as the predicted trajectory segment of the logic entity.

5. The method according to claim 2, wherein after the obtaining a current position deviation between a first current position and a second current position, the method further comprises:
predicting an initial predicted trajectory of the representation entity in accordance with the target movement parameter and the first current position; and
obtaining the first predicted trajectory for reducing the current position deviation in combination with a second weight sequence, the current position deviation, and the initial predicted trajectory, second weights in the second weight sequence being increased in order chronologically.

6. The method according to claim 1, wherein the driving movement of the representation entity based on the target animation comprises:
obtaining a trajectory deviation between an animation trajectory of the target animation and the first predicted trajectory;
obtaining a correction speed positively correlated with an animation moving speed of the target animation when the trajectory deviation is greater than a second deviation threshold;
determining a superimposed speed of the animation moving speed and the correction speed as a target moving speed of the representation entity; and
driving the movement of the representation entity in accordance with the target moving speed and the target animation.

7. The method according to claim 6, wherein after the obtaining a trajectory deviation between an animation trajectory of the target animation and the first predicted trajectory, the method further comprises:
driving the movement of the representation entity in accordance with the animation moving speed and the target animation when the trajectory deviation is less than or equal to the second deviation threshold.

8. The method according to claim 1, wherein before the driving movement of a logic entity based on the target movement parameter, the method further comprises:
receiving a position synchronization instruction transmitted by a server device, the position synchronization instruction comprising a second current position; and
controlling the logic entity to move to the second current position in response to the position synchronization instruction.

9. An electronic device comprising:
a memory, configured to store computer-executable instructions; and
a processor, configured to implement, when executing the computer-executable instructions stored in the memory, an animation processing method including:
determining a target movement parameter matching a target movement instruction for controlling movement of a virtual object based on a corresponding relationship between moving instructions and moving parameters;
driving movement of a logic entity based on the target movement parameter, the logic entity being configured to perform logic operations corresponding to the virtual object;
while driving the movement of the logic entity based on the target movement parameter, predicting a first predicted trajectory of a representation entity based on the target movement parameter, the representation entity being configured to represent the virtual object;
selecting, from a preset animation library, a target animation adapted to the first predicted trajectory;
driving movement of the representation entity based on the target animation; and
rendering a moving animation of the virtual object in a virtual scene based on the movement of the logic entity and the movement of the representation entity.

10. The electronic device according to claim 9, wherein the predicting a first predicted trajectory of a representation entity based on the target movement parameter comprises:
obtaining a current position deviation between a first current position and a second current position, the first current position being a position where the representation entity is currently located, and the second current position being a position where the logic entity is currently located;
predicting a second predicted trajectory of the logic entity in accordance with the target movement parameter and the second current position; and
predicting the first predicted trajectory of the representation entity near the second predicted trajectory in accordance with the current position deviation and the first current position.

11. The electronic device according to claim 10, wherein the predicting a second predicted trajectory of the logic entity in accordance with the target movement parameter and the second current position comprises:
predicting a predicted trajectory segment of the logic entity in accordance with the target movement parameter, a preset prediction duration, and a first current speed, the first current speed being a current moving speed of the logic entity; and
superimposing the second current position and the predicted trajectory segment to obtain the second predicted trajectory of the logic entity.

12. The electronic device according to claim 11, wherein the predicting a predicted trajectory segment of the logic entity in accordance with the target movement parameter, a preset prediction duration, and a first current speed comprises:
performing first sampling on the preset prediction duration to obtain a first sampling time sequence; and
performing, for each first sampling time in the first sampling time sequence, the following processing: predicting a first predicted position at the first sampling time in accordance with the target movement parameter and the first current speed;
obtaining a first predicted position sequence corresponding to the first sampling time sequence from the first predicted position at each first sampling time; and
determining a trajectory segment corresponding to the first predicted position sequence as the predicted trajectory segment of the logic entity.

13. The electronic device according to claim 10, wherein after the obtaining a current position deviation between a first current position and a second current position, the method further comprises:
predicting an initial predicted trajectory of the representation entity in accordance with the target movement parameter and the first current position; and
obtaining the first predicted trajectory for reducing the current position deviation in combination with a second weight sequence, the current position deviation, and the initial predicted trajectory, second weights in the second weight sequence being increased in order chronologically.

14. The electronic device according to claim 9, wherein the driving movement of the representation entity based on the target animation comprises:
obtaining a trajectory deviation between an animation trajectory of the target animation and the first predicted trajectory;
obtaining a correction speed positively correlated with an animation moving speed of the target animation when the trajectory deviation is greater than a second deviation threshold;
determining a superimposed speed of the animation moving speed and the correction speed as a target moving speed of the representation entity; and
driving the movement of the representation entity in accordance with the target moving speed and the target animation.

15. The electronic device according to claim 14, wherein after the obtaining a trajectory deviation between an animation trajectory of the target animation and the first predicted trajectory, the method further comprises:
driving the movement of the representation entity in accordance with the animation moving speed and the target animation when the trajectory deviation is less than or equal to the second deviation threshold.

16. The electronic device according to claim 9, wherein before the driving movement of a logic entity based on the target movement parameter, the method further comprises:
receiving a position synchronization instruction transmitted by a server device, the position synchronization instruction comprising a second current position; and
controlling the logic entity to move to the second current position in response to the position synchronization instruction.

17. A non-transitory computer-readable storage medium, storing computer-executable instructions, the computer-executable instructions, when executed by a processor of an electronic device, causing the electronic device to implement an animation processing method including:
determining a target movement parameter matching a target movement instruction for controlling movement of a virtual object based on a corresponding relationship between moving instructions and moving parameters;
driving movement of a logic entity based on the target movement parameter, the logic entity being configured to perform logic operations corresponding to the virtual object;
while driving the movement of the logic entity based on the target movement parameter, predicting a first predicted trajectory of a representation entity based on the target movement parameter, the representation entity being configured to represent the virtual object;
selecting, from a preset animation library, a target animation adapted to the first predicted trajectory;
driving movement of the representation entity based on the target animation; and
rendering a moving animation of the virtual object in a virtual scene based on the movement of the logic entity and the movement of the representation entity.

18. The non-transitory computer-readable storage medium according to claim 17, wherein the predicting a first predicted trajectory of a representation entity based on the target movement parameter comprises:
obtaining a current position deviation between a first current position and a second current position, the first current position being a position where the representation entity is currently located, and the second current position being a position where the logic entity is currently located;
predicting a second predicted trajectory of the logic entity in accordance with the target movement parameter and the second current position; and
predicting the first predicted trajectory of the representation entity near the second predicted trajectory in accordance with the current position deviation and the first current position.

19. The non-transitory computer-readable storage medium according to claim 17, wherein the driving movement of the representation entity based on the target animation comprises:
obtaining a trajectory deviation between an animation trajectory of the target animation and the first predicted trajectory;
obtaining a correction speed positively correlated with an animation moving speed of the target animation when the trajectory deviation is greater than a second deviation threshold;
determining a superimposed speed of the animation moving speed and the correction speed as a target moving speed of the representation entity; and
driving the movement of the representation entity in accordance with the target moving speed and the target animation.

20. The non-transitory computer-readable storage medium according to claim 17, wherein before the driving movement of a logic entity based on the target movement parameter, the method further comprises:
receiving a position synchronization instruction transmitted by a server device, the position synchronization instruction comprising a second current position; and
controlling the logic entity to move to the second current position in response to the position synchronization instruction.
